(19) United States
(12) Patent Application Publication
(10) Pub. No.: US 2006/0070473 A1
(43) Pub. Date: Apr. 6, 2006

(54) Rolling screw

(76) Inventor: Chuang-Pao Yang, Taichung (TW)

Correspondence Address: CHARLES E. BAXLEY, ESQ., 90 JOHN STREET, THIRD FLOOR, NEW YORK, NY, 10038, US

(21) Appl. No.: 10/949,107

(22) Filed: Sep. 24, 2004

(51) Int. Cl. F16H 1/24

(52) U.S. Cl. 74/424.91

(57) ABSTRACT

The present invention relates to a rolling screw whose characteristic is that there are two rows of rollers in the single groove of screw, the rollers in one of the two rows are in a loaded condition and the rollers in the other of the two rows are in an unloaded condition. The return path of the return unit is designed as a U-shaped path that allows the rollers in the same groove to complete a U-shaped turn around. Therefore, the present invention can avoid the uncertain and unsteady movement of the rollers.

### BACKGROUND OF THE INVENTION

1. Field of the Invention

The present invention relates to a rolling screw, and more particularly to a circulating mode of the rolling screw capable of enabling the rollers between the screw nut and the screw to change moving direction and to complete a circuit. The screw and the screw nut are allowed to move relative to each other for transmitting power.

2. Description of the Prior Arts

Rollers of a conventional rolling screw are generally circulated in three modes: external circulating mode (to complete the circuit by way of external means), internal circulating mode (to complete the circuit by way of internal means) and end-cap circulating mode (to complete the circuit by way of end cap). The external circulating mode means that a screw nut is exteriorly connected with a pipe that is in communication with a rolling path, so that the rollers are allowed to circulate infinitely. The internal circulating mode means that the deflecting unit of the screw nut is provided with an S-shaped return path connecting to two neighboring ridges, this structure allows the rollers to complete the circuit and move endlessly in the rolling path. The end-cup circulating mode refers to an S-shaped return path that is provided on a terminal surface of a screw nut for connecting the thread to a return hole, thus the rollers can be guided into the return hole so as to complete the circuit. The rollers of these three circulating modes don't move at the same level because they have to climb over the ridge of the threads of the screw during the circuit, so that the rollers are unlikely to run smoothly and may be jammed in the rolling path.

Furthermore, the rolling screw is also divided into two categories: single-thread-single-row-roller rolling screw and single-thread-multi-row-roller rolling screw, however, the circulating modes of these two type rolling screws are the same as those above-mentioned circulating modes. For example, U.S. Pat. No. 6,481,305 discloses a single-thread-single-row-roller rolling screw and U.S. Pat. No. 5,535,638 discloses a single-thread-multi-row-roller rolling screw, both of which are of external circulating mode in which the rollers exit the rolling path at one end via a tube and return to the rolling path at the other end, so as to complete the circuit. The rollers of these two U.S patents are also unlikely to move smoothly and may be jammed in the ball track.

To sum up, the return device is able to transfer the rollers from one end of the rolling path to the other via the return path. In these conventional circulating modes, the rollers are most likely to be blocked or twisted at both ends of the rolling path.

The present invention has arisen to mitigate and/or obviate the afore-described disadvantages.

### SUMMARY OF THE INVENTION

The primary object of the present invention is to provide a return device used on a rolling screw. The characteristic of this return device is that the rollers can complete the circuit without climbing over the ridge of the thread of the screw, the rolling path has fewer turning points so that the rollers can move more stably and smoothly.

First of all, the rollers in accordance with the present invention are designed to move and complete the circuit at a position equidistant from the axis of the screw, the rollers move in the space between the thread of the screw and that of the screw nut and are arranged in a groove in two rows, the rollers in one of the two rows are in a loaded condition and the rollers in the other of the two rows are in an unloaded condition.

Furthermore, to separate the two rows of the rollers from each other, the corresponding relation between the threads of the screw nut and the screw is changed from the conventional relation of ridge-to-ridge and groove-to-groove to ridge-to-groove and groove-to-ridge. Namely, the ridge of the screw is engaged in the groove of the screw nut, and in the groove of the screw is received the ridge of the screw nut. The rollers are disposed in the a space formed by the groove and the ridge of the screw nut and that of the screw, so that the two rows of rollers in the same groove will not affect each other and will move in an opposite direction.

Moreover, to connect the rolling paths of the two rows of rollers and create a complete endless rolling track, the screw nut is provided with a return unit which has a return path serving to connect the rolling paths of the two rows of rollers. In this way, the rollers are allowed to complete the circuit in a single groove of screw.

In addition, the return path of the return unit can be designed as a symmetrical and horizontal return path, and the simplest symmetrical and horizontal return path is the U-shaped path which allows the rollers in the same groove to complete a U-shaped turn around. The return path of the present invention is applicable either to spherical roller (rolling ball) or to cylindrical roller (cylindrical roller).

The present invention will become more obvious from the following description when taken in connection with the accompanying drawings, which show, for purpose of illustrations only, the preferred embodiment in accordance with the present invention.

### BRIEF DESCRIPTION OF THE DRAWINGS

FIG. 1 is an exploded view of a rolling screw in accordance with the present invention;

FIG. 2 shows the rolling path of the rollers on the screw in accordance with the present invention;

FIG. 3 is a cross sectional view of a screw nut in accordance with the present invention;

FIG. 4 is an amplified view of the return unit shown in FIG. 1;

FIG. 5 is a partial assembly cross sectional view of the screw and the screw nut in accordance with the present invention;

FIG. 6 is a partial assembly cross sectional view of the screw and the screw nut in another accordance with the present invention;

FIG. 7 is an amplified view of showing the rollers of FIG. 6.

### DETAILED DESCRIPTION OF THE PREFERRED EMBODIMENT

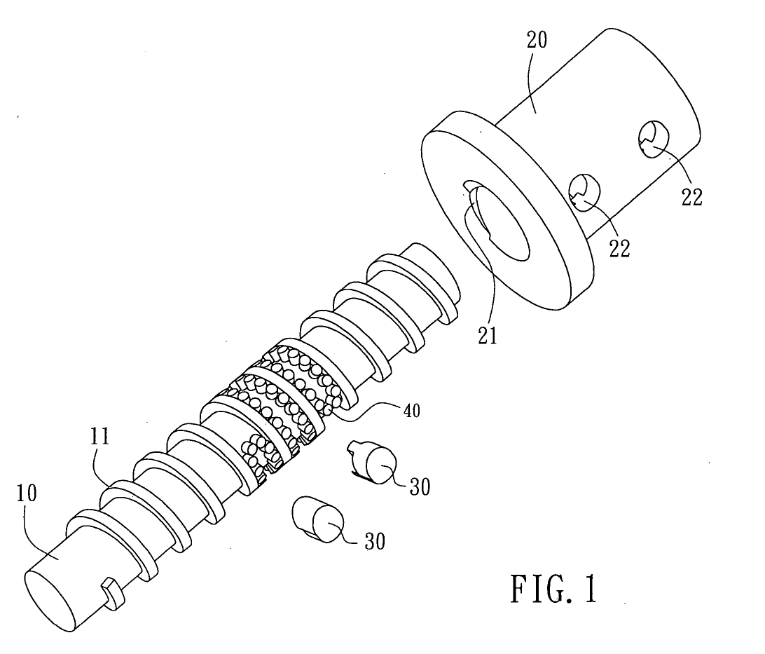

Referring to FIG. 1, which is an exploded view of a rolling screw in accordance with the present invention, a thread 11 is formed on the outer surface of a screw 10 and meshed with a screw nut 20. On the inner surface of the screw nut 20 is formed a thread 21 for meshing with the thread 11 of the screw 10. A plurality of rollers 40 move in the space formed between the threads 11 and 21, and in a plurality of return holes 22 of the screw nut 20 are correspondingly inserted plural return units 30 for allowing the rollers 40 to change the moving direction and to complete the circuit.

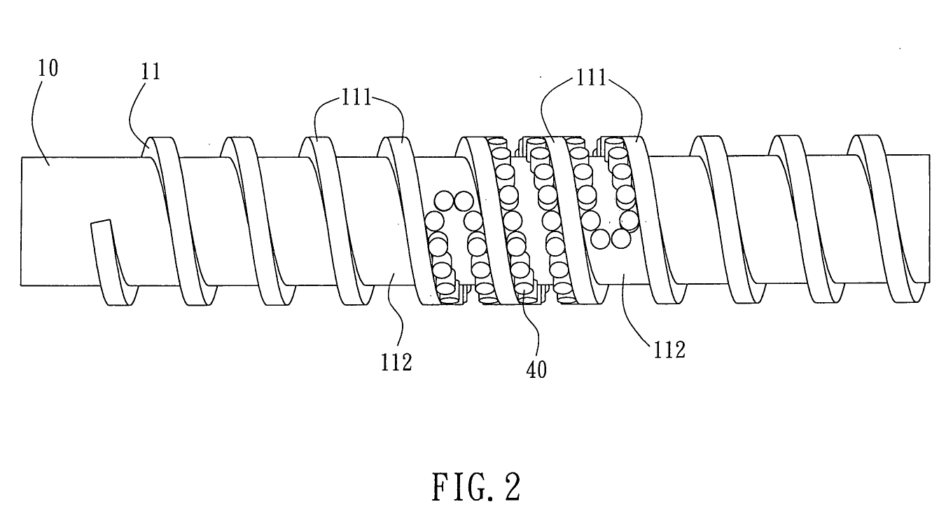

FIG. 2 shows the rolling path of the rollers on the screw in accordance with the present invention, each of the thread 11 of the screw 10 includes a ridge 111 and a groove 112. In the single groove 112 between two neighboring ridges 111 are provided two rows of rollers 40 which are designed to complete the circuit in the same groove 112.

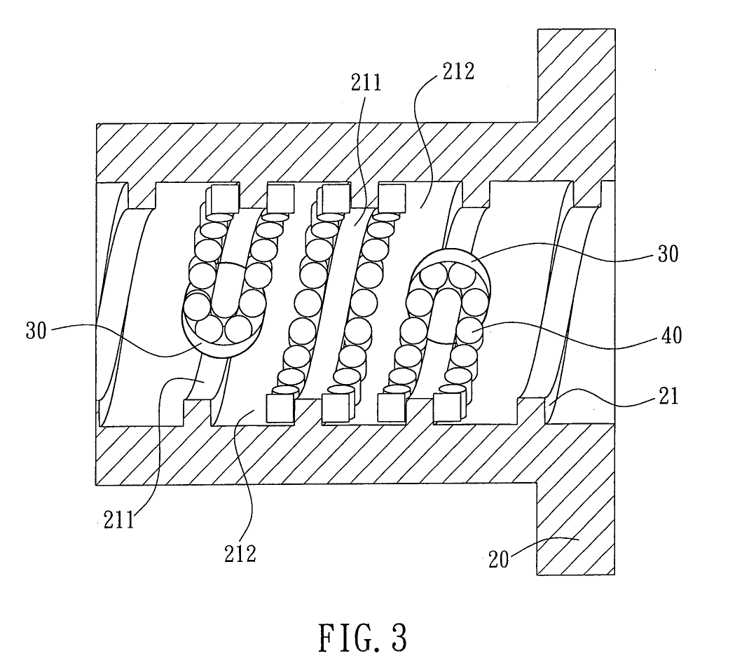

FIG. 3 is a cross sectional view of a screw nut in accordance with the present invention, the rollers 40 are arranged between the thread 21 of the screw nut 20 in two rows and move in the groove 212 between the neighboring ridges 211. Each of the return units 30 serves to connect the rolling paths of the rollers at both sides of the ridge 211 of the screw nut 20 together, so as to create an endless rolling path.

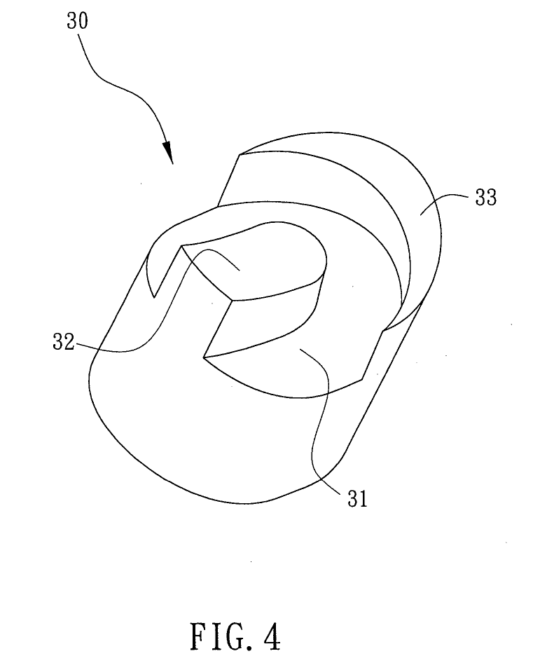

FIG. 4 is an amplified view of the return unit shown in FIG. 1, on the surface of the return unit 30 facing the screw 10 is formed an U-shaped return path 31 which is formed by an assistant block 32 and a stopping block 33 and serves to connect the rolling path of the two rows of rollers (not shown) in the single groove 112 of the screw 10, so that the rollers 40 are allowed to complete the circuit. The assistant block 32 is an extension of the ridge 211 of the screw nut 20 shown in FIG. 3 so as to make the rollers move smoothly, and the block 33 serves to change the moving direction of the rollers and to make them complete the circuit.

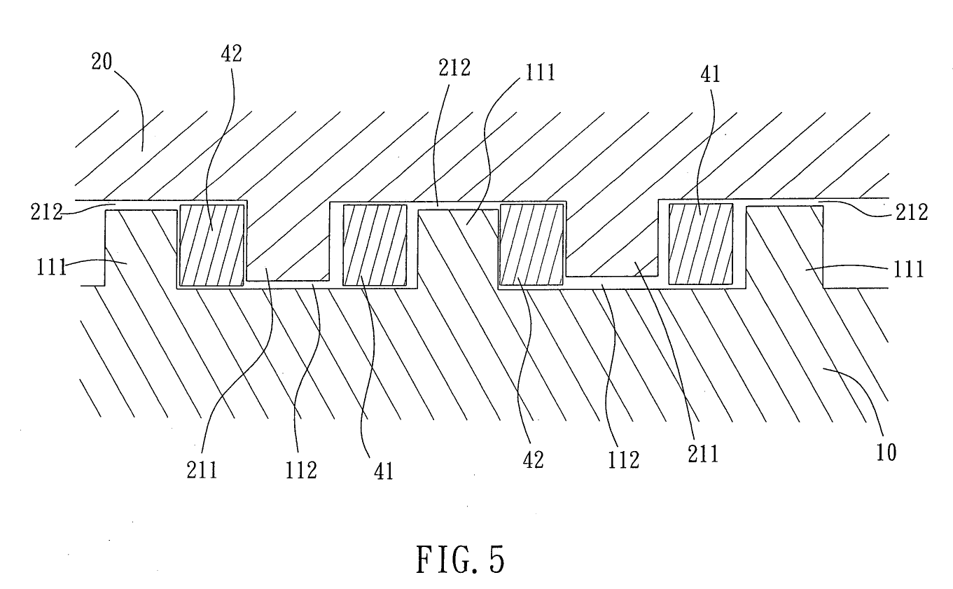

FIG. 5 is a partial assembly cross sectional view of the screw and the screw nut in accordance with the present invention, the ridges 111 of the thread on the screw 10 are engaged in the grooves 212 of the screw nut 20, whereas the ridges 211 of the screw nut 20 are engaged in the grooves 112 of the screw 10, so that the rollers 41, 42 are separated by the ridges 111, 211 and arranged in the grooves 112 and 212, respectively. At this moment, the rollers 41 in one of the grooves 112, 212 are in an unloaded condition, whereas the rollers 42 in the other of the grooves 112, 212 are in a loaded condition, and the loaded rollers 42 can be turned into the unloaded rollers 41 (can be changed from the loaded condition to the unloaded condition) by the return unit (not shown). Thereby, the two rows of the rollers 41, 42 in the grooves 112 and 212 are able to complete the circuit.

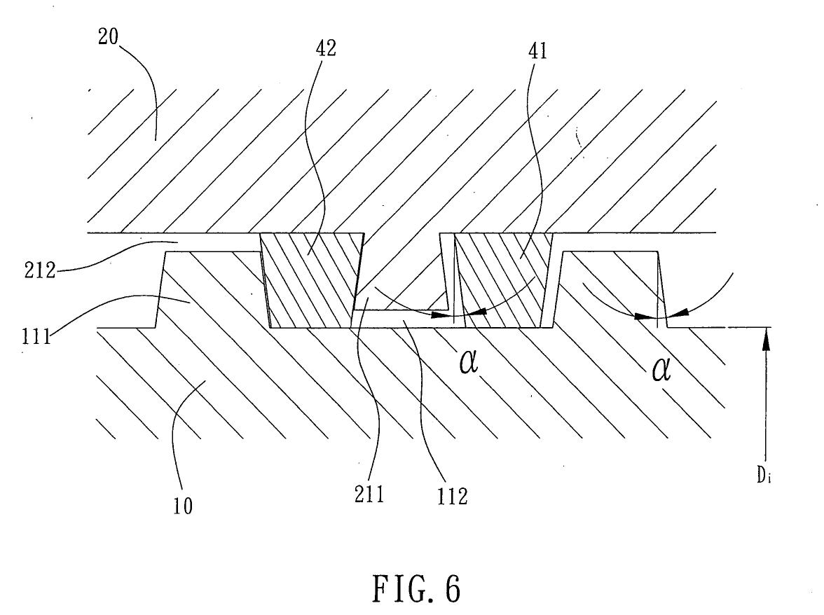

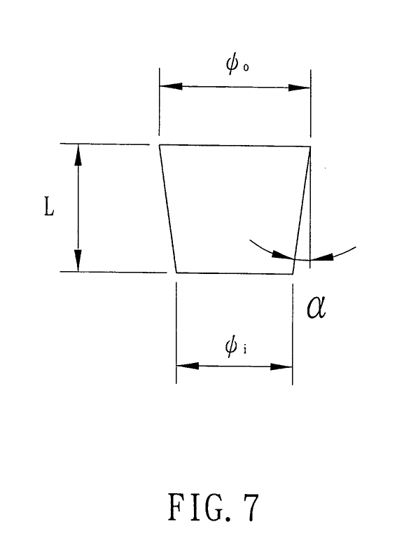

FIG. 6 is a partial assembly cross sectional view of the screw and the screw nut in another accordance with the present invention. FIG. 7 is an amplified view for showing the rollers of FIG. 6. The rollers 41, 42 in FIG. 6 are separated by the ridges 111, 211 and arranged in the grooves 112 and 212 in two rows, the main difference is that the rollers 41, 42 have an inclination of α, and the ridges 111, 211 also have an inclination of a for mating with the rollers 41, 42 and allowing the rollers 41, 42 to move more smoothly. As shown in FIG. 6, the diameter of the screw 10 is Dᵢ, the big diameter of the rollers 41, 42 is φₒ, the small diameter of the rollers 41, 42 is φᵢ, and the height of the rollers 41, 42 is L. When the rollers 41,42 are rolling smoothly and rotating 360 degrees about the screw 10, the number of circles that the rollers 41,42 rotated times the circumference of rollers 41,42 must be equal to the circumference of the screw 10, thus satisfying the equation: Dᵢ/φᵢ)=[(Dᵢ+2L)/φ. It can be learned from FIG. 7 that tan α=[(φₒ−φᵢ)/(2L), thus, the inclination α=tan⁻¹[(φₒ−φᵢ)/(2L).

While we have shown and described various embodiments in accordance with the present invention, it should be clear to those skilled in the art that further embodiments may be made without departing from the scope of the present invention.

What is claimed is:

1. A rolling screw comprising a screw, a screw nut and a plurality of rollers, a thread formed on an outer surface of the screw and meshed with the screw nut, on an inner surface of the screw nut formed a thread for meshing with the threads of the screw, wherein a ridge of the thread of the screw nut is engaged in a groove of the screw, the rollers are disposed in a space between the thread of the screw nut and that of the screw, in the groove of the screw the rollers are arranged in two rows and move in an opposite direction, on the screw nut is provided a return unit which has a return path used to be connected to rolling path of the two rows of the rollers, so that the two rows of rollers are allowed to complete a circuit in a single groove of the screw.

2. The rolling screw as claimed in claim 1, wherein the rollers are cylindrical rollers.

3. The rolling screw as claimed in claim 2, wherein each of the cylindrical rollers has an inclination of α.

4. The rolling screw as claimed in claim 3, wherein the relationship between the cylindrical rollers and the screw is represented as: (Dᵢ/φᵢ)=[(Dᵢ+2L)/φₒ].

5. The rolling screw as claimed in claim 2, wherein the ridge of the thread of the screw nut has an inclination of α, and α=tan⁻¹[(φₒ−φᵢ)/(2L)].

6. The rolling screw as claimed in claim 3, wherein the ridge of the thread of the screw nut has an inclination of α, and α=tan⁻¹[(φₒ−φᵢ)/(2L)].

7. The rolling screw as claimed in claim 2, wherein the ridge of the thread of the screw has an inclination of α, and α=tan⁻¹[(φₒ−φᵢ)/(2L)].

8. The rolling screw as claimed in claim 3, wherein the ridge of the thread of the screw has an inclination of α, and α=tan⁻¹[(φₒ−φᵢ)/(2L)].

9. The rolling screw as claimed in claim 1, wherein the return path of the return unit is U-shaped.

10. The rolling screw as claimed in claim 1, wherein the rollers are rolling balls.
